(19) United States
(12) Patent Application Publication
(10) Pub. No.: US 2014/0013270 A1
(43) Pub. Date: Jan. 9, 2014

(54) Multiple Chart Display

(71) Applicant: NAVICO HOLDING AS, Egersund (NO)

(72) Inventors: Stephen Thomas, Tulsa, OK (US); Matthew Hunt, Pittsburgh, PA (US)

(73) Assignee: Navico Holding AS, Egersund (NO)

(21) Appl. No.: 13/804,622

(22) Filed: Mar. 14, 2013

Related U.S. Application Data
(60) Provisional application No. 61/708,585, filed on Oct. 1, 2012.
(60) Provisional application No. 61/668,969, filed on Jul. 6, 2012.

(51) Int. Cl. G06F 3/0481

(52) U.S. Cl. CPC G06F 3/0481
USPC 715/781

(57) ABSTRACT

An apparatus and method for displaying marine electronic data. In one implementation, a non-transitory computer-readable medium has stored thereon a plurality of computer-executable instructions. When the plurality of computer-executable instructions are executed by a computer, the plurality of computer-executable instructions cause the computer to perform various actions. The actions may include receiving a user request for the computer to display two or more windows of chart data. The computer can then create the two or more windows on a screen of the computer. A first one of the two or more windows can display the chart data from a first source. A second one of the two or more windows can display the chart data from a second source.

### CROSS-REFERENCE TO RELATED APPLICATIONS

This application claims the benefit of U.S. Provisional Patent Application Ser. No. 61/668,969, filed Jul. 6, 2012, titled DUAL CHART DISPLAY, and the disclosure of which is incorporated herein by reference.

This application claims the benefit of U.S. Provisional Patent Application Ser. No. 61/708,585, filed Oct. 1, 2012, titled MULTIPLE CHART DISPLAY, and the disclosure of which is incorporated herein by reference.

### BACKGROUND

### Discussion of the Related Art

This section is intended to provide background information to facilitate a better understanding of various technologies described herein. As the section's title implies, this is a discussion of related art. That such art is related in no way implies that it is prior art. The related art may or may not be prior art. It should therefore be understood that the statements in this section are to be read in this light, and not as admissions of prior art.

Accurate data, including, for example, navigation, mapping, and the location of stationary and moving objects, can be very useful for marine activities. The operator of a marine vessel monitors marine traffic. A device that is easy to operate and that provides data in an easy to follow format can provide advantages to the vessel operator. Such advantages may include requiring less time to request and review information, which in turn provides the vessel operator with more time to monitor the marine traffic.

### SUMMARY

Described herein are implementations of various technologies for an apparatus and method for displaying marine electronic data. In one implementation, a non-transitory computer-readable medium has stored thereon a plurality of computer-executable instructions. When executed by a computer, the plurality of computer-executable instructions cause the computer to perform various actions. The actions may include receiving a user request for the computer to display two or more windows of chart data. The computer can then create the two or more windows on a screen of the computer. A first one of the two or more windows can display the chart data from a first source. A second one of the two or more windows can display the chart data from a second source.

Described herein are also implementations of various technologies for an apparatus for displaying chart data. The apparatus includes one or more processors, a screen, and memory. The memory has a plurality of executable instructions. When the executable instructions are executed by the one or more processors, the one or more processors may receive a user request for the one or more processors to display two or more windows of chart data. The one or more processors may then create the two or more windows on the screen. A first one of the two or more windows can display the chart data from a first source. A second one of the two or more windows can display the chart data from a second source.

Described herein are also implementations of various technologies for methods for displaying chart data on a multi function display (“MFD”). In one implementation, the method may include receiving a user request for the MFD to display the chart data in two or more windows. The two or more windows can then be created on a screen of the MFD. A first one of the two or more windows can display the chart data from a first source. A second one of the two or more windows can display the chart data from a second source.

The above referenced summary section is provided to introduce a selection of concepts in a simplified form that are further described below in the detailed description section. The summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

Implementations of various technologies will hereafter be described with reference to the accompanying drawings. It should be understood, however, that the accompanying drawings illustrate only the various implementations described herein and are not meant to limit the scope of various technologies described herein.

FIG. 1 is a schematic diagram of a multi-function display in accordance with various techniques described therein.

FIG. 2 is a schematic of a graphical user interface displaying data from multiple sources in accordance with various techniques described therein.

FIG. 3 is a flow diagram of a method for displaying marine electronics data in accordance with various techniques described therein.

FIG. 4 is a graphical user interface for requesting multiple display in accordance with various techniques described therein.

FIG. 5 is a graphical user interface for displaying marine navigation data from multiple sources in accordance with various techniques describe therein.

FIG. 6 is a graphical user interface for selecting multiple sources in accordance with various techniques described therein.

FIG. 7 is a graphical user interface for selecting particular sources for a window in accordance with various techniques described therein.

### DETAILED DESCRIPTION

The discussion below is directed to certain specific implementations. It is to be understood that the discussion below is only for the purpose of enabling a person with ordinary skill in the art to make and use any subject matter defined now or later by the patent “claims” found in any issued patent herein.

It is specifically intended that the claimed invention not be limited to the implementations and illustrations contained herein, but include modified forms of those implementations including portions of the implementations and combinations of elements of different implementations as come within the scope of the following claims. Nothing in this application is considered critical or essential to the claimed invention unless explicitly indicated as being “critical” or “essential.”

Reference will now be made in detail to various implementations, examples of which are illustrated in the accompanying drawings and figures. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, circuits and networks have not been described in detail so as not to unnecessarily obscure aspects of the implementations.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the invention. The first object or step, and the second object or step, are both objects or steps, respectively, but they are not to be considered the same object or step.

The terminology used in the description of the present disclosure herein is for the purpose of describing particular implementations only and is not intended to be limiting of the present disclosure. As used in the description of the present disclosure and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

“Alternatively” shall not be construed to only pertain to situations where the number of choices involved is exactly two, but rather refers to another possibility among many other possibilities.

Additionally, various technologies and techniques described herein include receiving user requests for a number of different operations. In certain instances, the user request for a particular operation will be explicitly described. It shall be understood that “user request”, “user can request”, or “user selection”, shall also include, but are not limited to, touching the screen, double tapping the screen (tapping the screen twice in rapid succession), pressing a particular physical or virtual button, making a selection from a menu, placement of a cursor at a particular location, stylus pointing, mouse selection, an audible command, as well as the explicit description of the “user request”, “user can request”, or “user selection” for the particular operation.

### Multifunction Display

Implementations of various technologies described herein may be operational with numerous general purpose or special purpose computing system environments or configurations. Examples of well known computing systems, environments, and/or configurations that may be suitable for use with the various technologies described herein include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The various technologies described herein may be implemented in the general context of computer-executable instructions, such as program modules, being executed by a computer. Generally, program modules include routines, programs, objects, components, data structures, etc. that performs particular tasks or implement particular abstract data types. Further, each program module may be implemented in its own way, and all need not be implemented the same way. While program modules may all execute on a single computing system, it should be appreciated that, in some implementations, program modules may be implemented on separate computing systems or devices adapted to communicate with one another. A program module may also be some combination of hardware and software where particular tasks performed by the program module may be done either through hardware, software, or both.

The various technologies described herein may also be implemented in distributed computing environments where tasks are performed by remote processing devices that are linked through a communications network, e.g., by hardwired links, wireless links, or combinations thereof. In a distributed computing environment, program modules may be located in both local and remote computer storage media including memory storage devices.

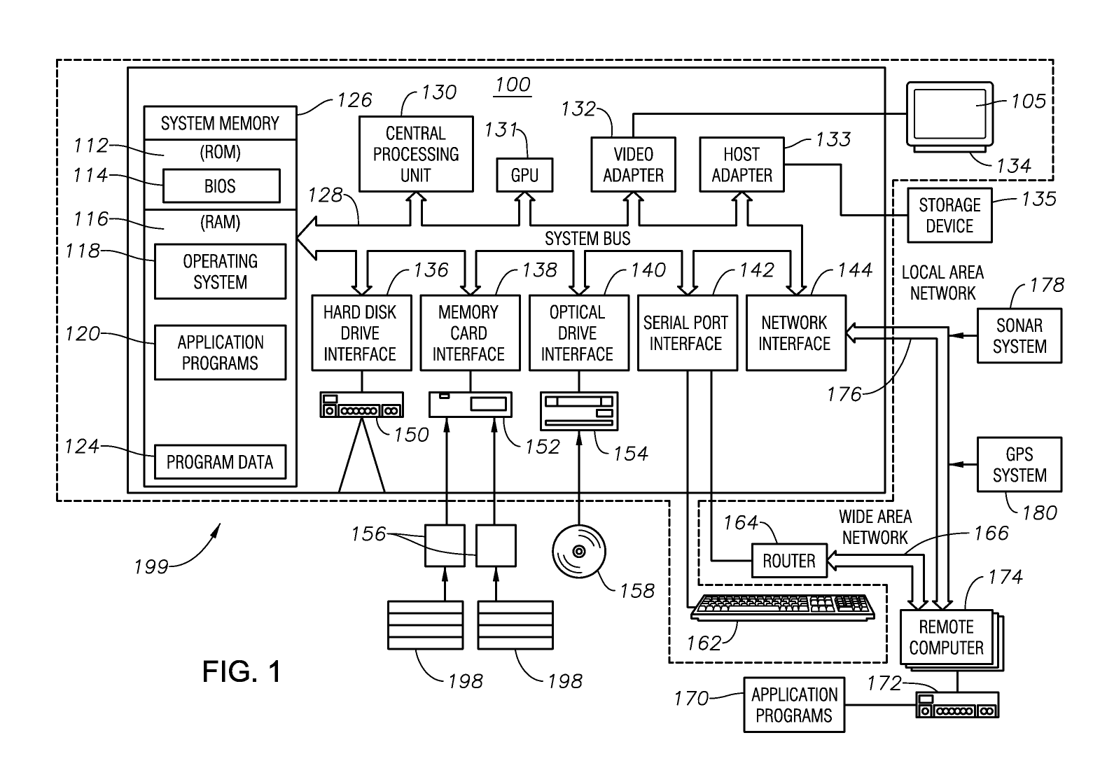

FIG. 1 illustrates a schematic diagram of a multi-function display 199 comprising a computing system 100 in which the various technologies described herein may be incorporated and practiced. The computing system 100 may be a conventional desktop, a handheld device, personal digital assistant, a server computer, electronic device/instrument, laptop, tablet, or part of a navigation system, marine electronics, or sonar system. It should be noted, however, that other computer system configurations may be used.

The computing system 100 may include a central processing unit (CPU) 130, a system memory 126, a graphics processing unit (GPU) 131 and a system bus 128 that couples various system components including the system memory 126 to the CPU 130. Although only one CPU 130 is illustrated in FIG. 1, it should be understood that in some implementations the computing system 100 may include more than one CPU 130.

The CPU 130 can include a microprocessor, a microcontroller, a processor, a programmable integrated circuit, or a combination thereof. The CPU 130 can comprise an off-the-shelf processor such as a Reduced Instruction Set Computer (RISC™), or a Microprocessor without Interlocked Pipeline Stages (MIPS™) processor, or a combination thereof. The CPU 130 may also include a proprietary processor.

The GPU 131 may be a microprocessor specifically designed to manipulate and implement computer graphics. The CPU 130 may offload work to the GPU 131. The GPU 131 may have its own graphics memory, and/or may have access to a portion of the system memory 126. As with the CPU 130, the GPU 131 may include one or more processing units, and each processing unit may include one or more cores.

The CPU 130 may provide output data to a GPU 131. The GPU 131 may generate graphical user interfaces that present the output data. The GPU 131 may also provide objects, such as menus, in the graphical user interface. A user may provide inputs by interacting with the objects. The GPU 131 may receive the inputs from interaction with the objects and provide the inputs to the CPU 130. A video adapter 132 may be provided to convert graphical data into signals for a monitor 134. The monitor 134 includes a screen 105. The screen 105 can be sensitive to heat or touching (now collectively referred to as a “touch screen”).

The system bus 128 may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. The system memory 126 may include a read only memory (ROM) 112 and a random access memory (RAM) 116. A basic input/output system (BIOS) 114, containing the basic routines that help transfer information between elements within the computing system 100, such as during start-up, may be stored in the ROM 112.

The computing system 100 may further include hard disk drive interface(s) 136 for reading from and writing to a hard disk(s) 150, memory card reader(s) 152 for reading from and writing to a removable memory card(s) 156, and optical disk drive(s) 154 for reading from and writing to removable optical disk(s) 158, such as a CD ROM or other optical media. The hard disk(s) 150, the memory card reader(s) 152, and the optical disk drive 154(s) may be connected to the system bus 128 by a hard disk drive interface 136, a memory card reader interface 138, and an optical drive interface 140, respectively. The drives and their associated computer-readable media may provide nonvolatile storage of computer-readable instructions, data structures, program modules and other data for the computing system 100.

Although the computing system 100 is described herein as having hard disk(s), removable memory card(s) 156 and removable optical disk(s) 158, it should be appreciated by those skilled in the art that the computing system 100 may also include other types of computer-readable media that may be accessed by a computer. For example, such computer-readable media may include computer storage media and communication media. Computer storage media may include volatile and non-volatile, and removable and non-removable media implemented in any method or technology for storage of information, such as computer-readable instructions, data structures, program modules or other data. Computer storage media may further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computing system 100. Communication media may embody computer readable instructions, data structures, program modules or other data in a modulated data signal, such as a carrier wave or other transport mechanism and may include any information delivery media. The term “modulated data signal” may mean a signal that has one or more of its characteristics set or changed in such a manner as to encode information in the signal. By way of example, and not limitation, communication media may include wired media such as a wired network or direct-wired connection, and wireless media such as acoustic, RF, infrared and other wireless media. The computing system 100 may also include a host adapter 133 that connects to a storage device 135 via a small computer system interface (SCSI) bus, a Fiber Channel bus, an eSATA bus, or using any other applicable computer bus interface. The computing system 100 can also be connected to a router 164 to establish a wide area network (WAN) 166 with one or more remote computers 174. The remote computers 174 can also include hard disks 172 that store application programs 170.

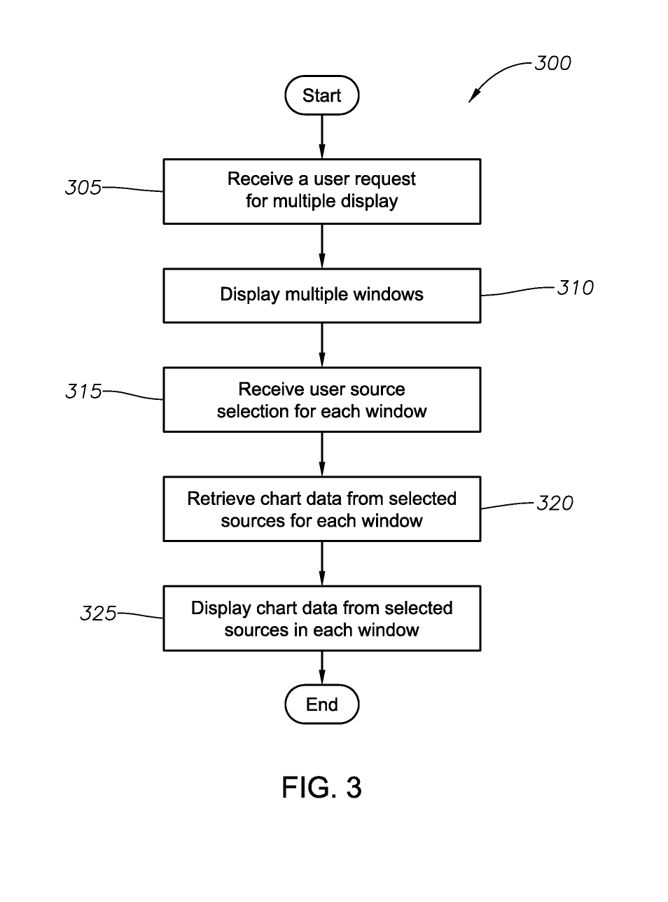

A number of program modules may be stored on the hard disk(s) 150, memory card(s) 156, optical disk(s) 158, ROM 112 or RAM 116, including an operating system 118, one or more application programs 120 and program data 124. In certain implementations, the hard disk 150 may store a database system. The database system could include, for example, recorded points. The application programs 120 may include various mobile applications (“apps”) and other applications configured to perform various methods and techniques described herein. For example, the one or more application programs 120 may perform the actions described in the flow diagram(s), e.g., FIG. 3, presented herein. The operating system 118 may be any suitable operating system that may control the operation of a networked personal or server computer.

A user may enter commands and information into the computing system 100 through input devices such as buttons 162. Other input devices may include a microphone (not shown). These and other input devices may be connected to the CPU 130 through a serial port interface 142 coupled to system bus 128, but may be connected by other interfaces, such as a parallel port, game port or a universal serial bus (USB).

Certain implementations may be configured to be connected to a GPS system 180, radar system 179, and/or a sonar system 178. The GPS system 180, radar system 179, and/or sonar system 178 may be connected via the network interface 144. The computing system 100, the monitor 134, the screen 105, and the buttons 162 may be integrated into a console, now referred to as a multifunction display (MFD) 199.

In certain implementations, the MFD 199 can be configured to simultaneously display marine electronics or navigation data from multiple sources 198. The marine electronics data may include chart data, radar data, sonar data, steering data, dashboard data, cartography data and the like. In one implementation, the source 198 provides a data structure that includes a collection of marine electronics, e.g., chart data. A source 198 can either be provided by different companies (or subsidiary) or may be different lines of products from the same company. In some implementations, the source may further include programs that allow the user to manipulate, e.g., mover or zoom, the marine electronics data. Alternatively, the software or programs required to manipulate the marine electronics data may already be stored in the MFD 199. The data structure from the sources 198 may stored on removable memory such as a memory card 156 or an optical disk 158. The sources 198 can also be accessed over a network such as the internet via network interface 144. For example, the user may buy a subscription to a source 198. Different companies, such as Navionics™ and Jeppesen™ sell sources that can be written in a proprietary format and can also be encrypted according to a particular data encryption standard.

According to certain implementations, the MFD 199 can simultaneously display chart data from two or more sources 198. For example, the MFD 199 can display two or more windows on the screen 105. Each window can display chart data from a different respective source 198. In certain implementations, the different sources can include chart data from the same region. However, the different sources can include different information about the same region. A marine vessel operator wishing to be able to view information from both sources about the region can advantageously display the chart data from different sources about the same region, simultaneously. Alternatively, the sources can simultaneously display information about different regions.

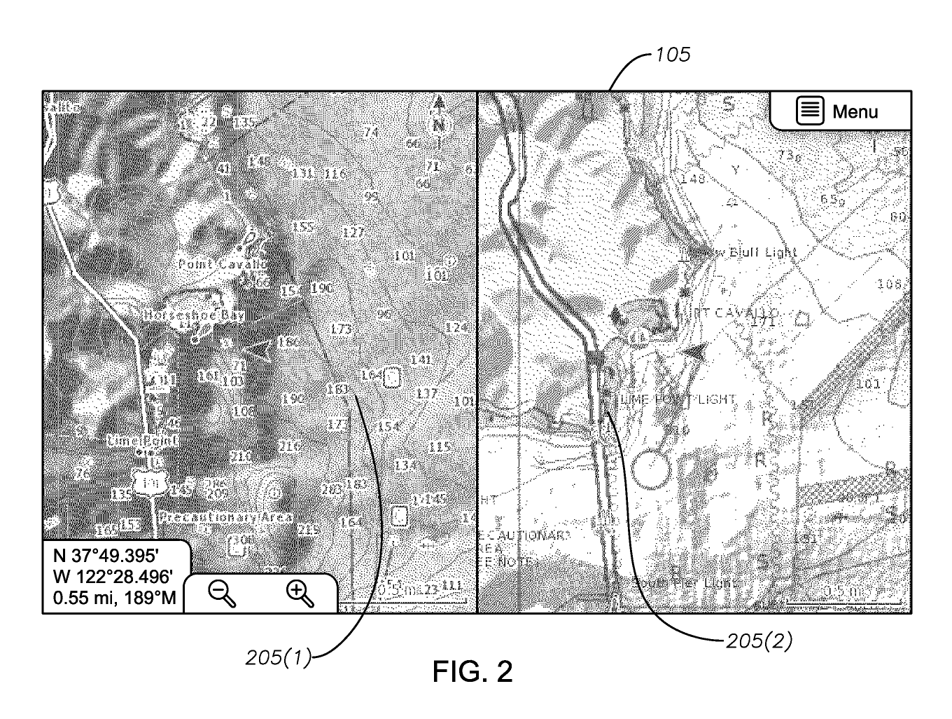

FIG. 2 is a schematic diagram of the screen 105 displaying chart data from different sources 198 in accordance with various techniques described therein. For purposes of illustration, the screen 105 displays two windows 205(1), 205(2). Each window displays marine electronics data from a different source 198. Although only two windows are shown, it should be understood that more than two windows can be displayed by the MFD 199.

In certain implementations, the user can selectively interact with the marine chart data from the different sources. For example, the user can zoom the chart data in one window 205 without affecting the chart data in the other window(s) 205. In the case where the screen 105 is a touch screen, the user can move the chart data inside a window by finger swiping the particular chart data. Likewise, the user can zoom the chart data out by pinching (place two fingers onto the window and moving them towards each other), or zoom the chart data in by reverse pinching (place two fingers onto the window and moving them apart).

FIG. 3 is a flow diagram of a method 300 for displaying navigation data in accordance with various techniques described therein. It should be understood that while the operational flow diagram indicates a particular order of execution of the operations, in other implementations, the operations might be executed in a different order. Further, in some implementations, additional operations or steps may be added to the method 300. Likewise, some operations or steps may be omitted.

At block 305, the MFD 199 receives a user request for multiple display. In one implementation, the request for multiple display may be a request to display two different types of chart data in a split screen. Although various implementations described herein are with reference to displaying two different types of chart data in a split screen, it should be understood that in some implementations three or more different types of chart data may be displayed in screen split in three or more equal parts. In another implementation, the request for multiple display may be implemented by selecting a predefined bookmark for the multiple display. In yet another implementation, the MFD 100 may provide a number of bookmarks for providing varying number of multiple displays, e.g., dual split screen, triple split screen, etc.

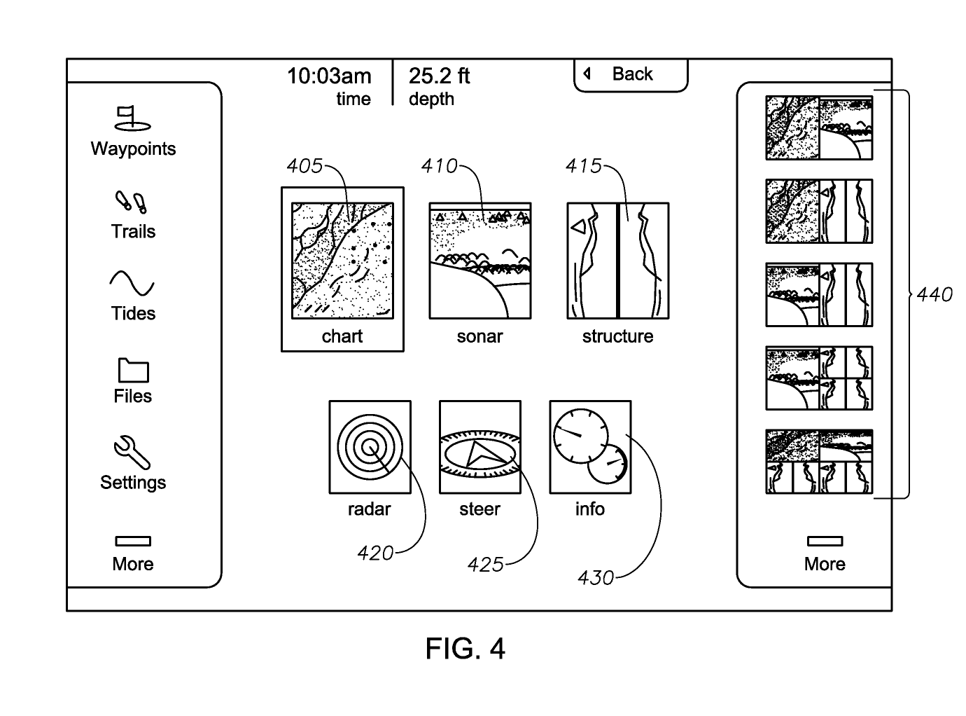

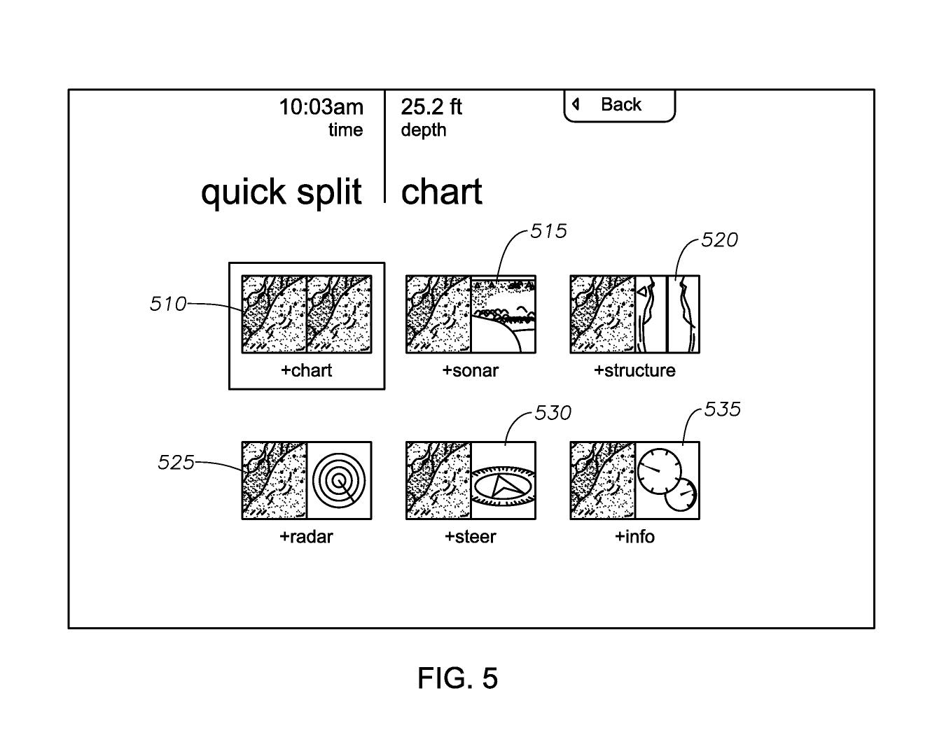

FIGS. 4 and 5 illustrate one implementation in which the request for multiple display may be made. FIG. 4 illustrates a graphical user interface that displays icons representing various marine electronics data that can be displayed on a multiple display, e.g., a dual split screen. As shown in FIG. 4, the various marine electronics data may include chart data 405, sonar data 410, structure data 415, radar data 420, steering data 425, and dashboard information 430. In this implementation, the user can request the multiple display by touching the chart data icon 405 in excess of a predetermined amount of time. For instance, the user may select the chart data 405 to be displayed in at least one of the multiple display.

After pressing the chart data icon 405 in excess of the predetermined amount of time, the MFD 199 displays a menu of selections for displaying different combinations of marine electronic data that can be displayed along with the chart data as a multiple display. FIG. 5 illustrates icons 505 . . . 530 representing the different combinations of marine electronic data that can be displayed simultaneously with the chart data. As shown in FIG. 5, the user may select another chart data to be displayed with the chart data that corresponds to the chart data icon 405 previously shown in FIG. 4.

In certain implementations, the screen can display predetermined dual source split screen icons 440. The predetermined dual source split screen icons 440 graphically indicate the sources that will be displayed if selected. Accordingly, in certain implementations, the user request can include selection of a dual source split screen icon 440.

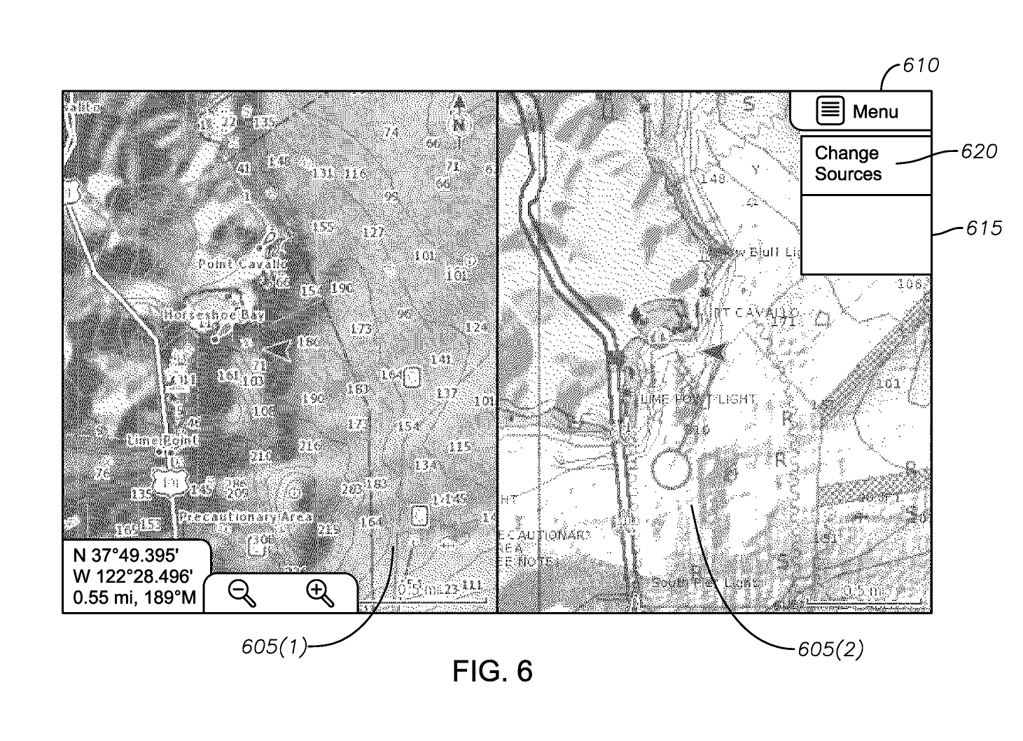

Returning to FIG. 3, at block 310, upon receiving the request for multiple display, the MFD 199 displays multiple windows 605 (shown in FIG. 6). The windows 605 can initially display data from default sources that may or may not be the same. Each window 605(1) and 605(2) can provide data from the same source 198 or different sources 198.

At block 315, the MFD 199 may receive a user selection of a source 198 for each window 205. This step may be further illustrated in FIG. 6. As illustrated in FIG. 6, the graphical user interface may include a menu 610. Selection of the menu 610 causes a menu bar 615 to drop down. The menu bar 615 may include a choice for changing sources 620. In certain implementations, the user can select menu 610 and the choice for changing sources 620 by touching the screen. The user can then select a window, e.g., window 605(1), in which to change the source 198 by touching the window. After selecting the window, e.g., 605(1), the window may display the possible sources that are available.

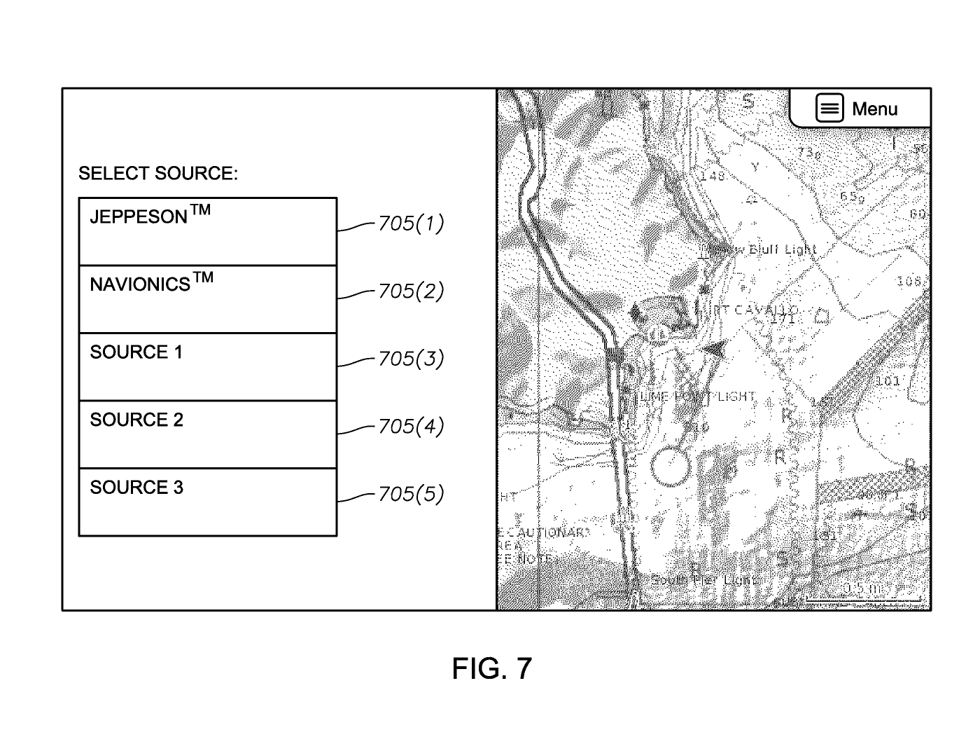

Referring now to FIG. 7, there is illustrated a block diagram of graphical user interface for selecting a source 198 for a window. The window 605(1) displays a list of selectable available sources 705(1) . . . 705(5), e.g., from Navionics™ and Jeppesen™. In certain implementations, the user can select a source 198 by touching the desired source selection 705.

Upon receiving the source 198 selection for each window 605(1), 605(2), the MFD 199 retrieves data from each of the selected sources 198 at block 320. At block 325, the MFD 199 displays data from each of the selected sources 198 in each respective window 605.

In certain implementations, the source 198 may encrypt and format, according to a proprietary format, its own contents. As such, when the MFD 199 retrieves chart data from multiple sources, the MFD 199 may decrypt the data from the sources and convert the format from the sources. The chart data may be decrypted according to the source's respective encryption standard.

It should be noted that while various implementations described herein show the MFD 199 displaying source data from two sources 198, in some implementations, the MFD 199 can split the screen 105 into more than two windows 205 and display chart data from more than three sources.

While the foregoing is directed to implementations of various technologies described herein, other and further implementations may be devised without departing from the basic scope thereof, which may be determined by the claims that follow. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A non-transitory computer-readable medium having stored thereon a plurality of computer-executable instructions which, when executed by a computer, cause the computer to:
receive a user request for the computer to display two or more windows of chart data;
create the two or more windows on a screen of the computer; and
display the chart data from a first source in a first one of the two or more windows and from a second source in a second one of the two or more windows.

2. The non-transitory computer-readable medium of claim 1, wherein the plurality of computer-executable instructions that cause the computer to receive the user request comprise computer-executable instructions that cause the computer to:
receive a first user selection having the first source; and
receive a second user selection having the second source.

3. The non-transitory computer-readable medium of claim 1, wherein the chart data from the first source and the chart data from the second source cover the same geographic region.

4. The non-transitory computer-readable medium of claim 1, wherein the first source uses a first format for the chart data and wherein the second source uses a second format for the chart data, wherein the first format is different from the second format.

5. The non-transitory computer-readable medium of claim 1, wherein the first source and the second source uses the same format for the chart data.

6. The non-transitory computer-readable medium of claim 1, wherein the first source uses a first data encryption standard for the chart data and wherein the second source uses a second data encryption standard for the chart data, wherein the first data encryption standard is different from the second data encryption standard.

7. The non-transitory computer-readable medium of claim 6, wherein the plurality of computer-executable instructions also cause the computer to decrypt the chart data from the first source according to the first data encryption standard and decrypt the chart data from the second source according to the second data encryption standard.

8. The non-transitory computer-readable medium of claim 1, wherein the first source and the second source uses the same standard for the chart data.

9. An apparatus for displaying chart data, said apparatus comprising:
one or more processors;
a screen;
memory having a plurality of executable instructions which, when executed by the one or more processors, cause the one or more processors to:
receive a user request for the one or more processors to display two or more windows of chart data;
create the two or more windows on the screen; and
display the chart data from a first source in a first one of the two or more windows and from a second source in a second one of the two or more windows.

10. The apparatus of claim 9, wherein the plurality of executable instructions that cause the one or more processors to receive the user request further comprise executable instructions that cause the one or more processors to:
receive a first user selection having the first source; and
receive a second user selection having the second source.

11. The apparatus of claim 9, wherein the chart data from the first source and the chart data from the second source cover the same geographic region.

12. The apparatus of claim 9, wherein the first source uses a first format for the chart data and wherein the second source uses a second format for the chart data, wherein the first format is different from the second format.

13. The apparatus of claim 9, wherein the first source and the second source use the same format for the chart data.

14. The apparatus of claim 9, wherein the first source uses a first data encryption standard for the chart data and wherein the second source uses a second data encryption standard for the chart data, wherein the first data encryption standard is different from the second data encryption standard.

15. The apparatus of claim 14, wherein the plurality of executable instructions also cause the one or more processors to decrypt the chart data from the first source according to the first data encryption standard and decrypt the chart data from the second source according to the second data encryption standard.

16. The apparatus of claim 9, wherein the first source and the second source use the same encryption standard for the chart data.

17. The apparatus of claim 9, wherein at least one of the first source and the second source is stored on a removable memory.

18. A method for displaying chart data on a multi function display (“MFD”), comprising:
receiving a user request for the MFD to display the chart data in two or more windows;
creating the two or more windows on a screen of the MFD; and
displaying the chart data from a first source in a first one of the two or more windows and from a second source in a second one of the two or more windows.

19. The method of claim 18, wherein receiving the user request further comprises:
receiving a first user selection having the first source; and
receiving a second user selection having the second source.

20. The method of claim 17, wherein at least one of the first source and the second source is stored on a removable memory.
